(19) United States
(12) Patent Application Publication
(10) Pub. No.: US 2015/0154436 A1
(43) Pub. Date: Jun. 4, 2015

(54) Methods and Apparatuses of Identity Skin for Access Control

(71) Applicants: Weidong Shi, Pearland, TX (US); Yang Lu, Pearland, TX (US)

(72) Inventors: Weidong Shi, Pearland, TX (US); Yang Lu, Pearland, TX (US)

(21) Appl. No.: 14/093,255

(22) Filed: Nov. 29, 2013

(51) Int. Cl. G06K 9/00

(52) U.S. Cl. CPC G06K 9/00006

(57) ABSTRACT

The present invention describes methods and apparatuses for sensing user identity by a mobile computing apparatus with an identity skin comprising, at least one biometric sensor; a readout circuit coupling with the biometric sensor; and a connector wherein said connector coupling the identity skin with a mobile computing apparatus and said connector comprising at least one input and/or output port.

### BACKGROUND OF THE INVENTION

### Field of the Invention

This invention relates to mobile identity management using identity skin wherein said identity skin comprises at least one biometric sensor, a readout circuit, and a connector that can couple said identity skin with a mobile computing apparatus.

The present application is a continuation-in-part of U.S. application Ser. No. 13/459,207, with the title “Methods and Apparatus of Integrating Fingerprint Imagers with Touch Panels and Displays”, filed Apr. 29, 2012; The present application is also a continuation-in-part of U.S. application Ser. No. 13/667,235, with the title “Methods and Apparatus for Managing Service Access Using a Touch-Display Device Integrated with Fingerprint Imager”, filed Nov. 2, 2012. The present application is also a continuation-in-part of U.S. application Ser. No. 13/757,993, with the title “Methods and Apparatuses of Transparent Fingerprint Imager Integrated with Touch Display Device”, filed Feb. 4, 2013. The present application is also a continuation-in-part of U.S. application Ser. No. 13/851,086, with the title “Methods and Apparatuses of User Interaction Control with Touch Display Device Integrated with Fingerprint Imager”, filed Mar. 26, 2013. The present application is also a continuation-in-part of U.S. application Ser. No. 13/887,351, with the title “Methods and Apparatuses of Unified Capacitive Based Sensing of Touch and Fingerprint”, filed May 5, 2013. The present application is also a continuation-in-part of U.S. application Ser. No. 14/059,592, with the title “Methods and Apparatuses of touch-fingerprinting Display”, filed Oct. 22, 2013. All of which are hereby incorporated by reference in their entireties.

### BRIEF DESCRIPTION OF THE DRAWINGS

The invention may be better understood, and further advantages and uses thereof more readily apparent, when considered in view of the following detailed description of exemplary embodiments and examples, taken with the accompanying diagrams, in which:

FIG. 1 is a block diagram showing, in one exemplary embodiment of the present invention, the components of an identity skin comprising, a biometric sensor, a readout circuit, and a connector that couples said identity skin with a mobile computing apparatus;

FIG. 2 is a block diagram showing, in one exemplary embodiment of the present invention, an alternative arrangement of identity skin;

FIG. 3 is a block diagram showing, in one exemplary embodiment of the present invention, the components of an identity skin comprising, one or a plurality of biometric sensors, a readout circuit, and a connector that comprises a connection port to a mobile computing apparatus and additional input/output ports;

FIG. 4 is a block diagram showing, in one alternative exemplary embodiment of the present invention, the components of an identity skin comprising, one or a plurality of fingerprint imagers;

FIG. 5 is a block diagram showing, in one alternative exemplary embodiment of the present invention, the components of an identity skin comprising, a palm print imager;

FIG. 6 is a flow chart showing, in one exemplary embodiment of the present invention, the method of using identity skin for enforcing access control;

FIG. 7 is a flow chart showing, in one exemplary embodiment of the present invention, the method of using identity skin for access control over networks; and

FIG. 8 is a flow chart showing, in one alternative exemplary embodiment of the present invention, the method of using identity skin for accessing service over networks.

While the patent invention shall now be described with reference to the embodiments shown in the drawings, it should be understood that the intention is not to limit the invention only to the particular embodiments shown but rather to cover alterations, modifications and equivalent arrangements possible within the scope of appended claims. Throughout this discussion that follows, it should be understood that the terms are used in the functional sense and not exclusively with reference to a specific embodiment, or implementation.

### DETAILED DESCRIPTION OF THE PREFERRED EMBODIMENTS

Discussion in this section is intended to provide a brief description of some exemplary embodiments of the present invention.

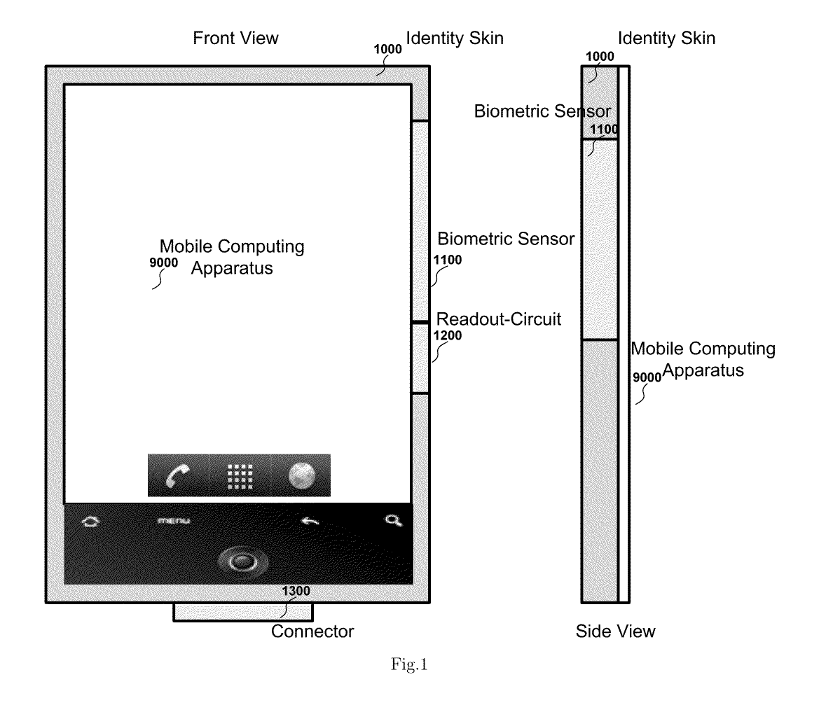

FIG. 1 is a block diagram showing, in one exemplary embodiment of the present invention, the components of an identity skin (1000) comprising, a biometric sensor (1100), a readout circuit (1200), and a connector (1300) that couples said identity skin with a mobile computing apparatus (e.g., laptop, or tablet, or notebook, or PDA, or mobile Internet device, or mobile phone, or handheld gaming device, or handheld computer, or netbook) (9000).

In one exemplary embodiment, an identity skin (1000) comprises, one or a plurality of biometric sensors (e.g., fingerprint imager, or palm print imager, or finger vein imager), a readout circuit, and a connector that couples the identity skin with a mobile computing apparatus.

A fingerprint imager is an electronic device used to capture a digital image of the fingerprint pattern. The captured image can be digitally processed to create a biometric template (e.g., a collection of extracted features) which is stored and used for matching. Depending on the embodiment, fingerprint imagers include but not limited to optical fingerprint imagers, or ultrasonic fingerprint imagers, or thermal fingerprint imagers, or capacitive fingerprint imagers, or MEMS (microelectromechanical systems) based fingerprint imagers, or fingerprint imagers built from nano materials (e.g., nano tubes, or nano wires).

A palm print imager is an electronic device used to capture a digital image of the palm region of a hand. Depending on the embodiments, a palm print image taken by a palm print imager can be an image of part of the palm region of a hand. The palm consists of principal lines, wrinkles and epidermal ridges. Depending on the embodiments, a palm print image may also contain other information such as texture, or indents, or marks.

In one exemplary embodiment, a palm print imager can comprise a device that converts an optical image into an electronic signal (e.g., digital charge-coupled device (CCD), or complementary metal oxide semiconductor (CMOS) active pixel sensors). In additional exemplary embodiment, a palm print imager can comprise infrared sensor array or a thermopile sensor array. A thermopile sensor is an electronic device that converts thermal energy into electrical energy.

A finger vein imager is an electronic device used to capture a digital image of human finger vein patterns beneath the skin's surface. The captured image can be digitally processed to create a biometric template (e.g., a collection of extracted features) which is stored and used for matching. In one exemplary embodiment, a finger vein imager can comprise an array of near-infrared LEDs (light-emitting diode), a CCD (charge-coupled device) imager. The hemoglobin in the blood absorbs near-infrared LED light, which makes the vein system appear as a dark pattern of lines.

Depending on the embodiments, a biometric imager can take any form (e.g., regular shape, or irregular shape, or planar shape, or 3D shape). Furthermore, in some exemplary embodiments, a biometric sensor can be overlayed on top of flexible (e.g., plastic) and/or transparent substrate (e.g., glass).

In accordance with the present invention, a mobile computing apparatus can comprise one or multiple transceivers. A transceiver (e.g, RF transceiver, ethernet transceiver) is a device comprising both transmitter and receiver handling circuitry. A RF Transceiver uses RF (radio frequency) modules for data transmission.

Depending on the implementations, an embodiment of a mobile computing apparatus can comprise one or a plurality of transceivers (e.g., WiFi transceivers, or cellular transceivers, or ethernet transceivers, or bluetooth transceiver).

A mobile computing apparatus (9000) can comprise one or a plurality of control processing elements. A control processing element is an electronic circuit which executes computer programs. A control processing element can be implemented as system on a chip (SoC). A system on a chip or system on chip (SoC or SOC) is an integrated circuit (IC) that integrates components of a computer or other electronic system into a single chip. It may contain digital, or analog, or mixed-signal, or radio-frequency functions all on a single chip substrate. Sometimes, a SoC processor designed for supporting applications executed by a mobile computing system (e.g., tablet, or mobile phone, or mobile Internet device, or handheld gaming device, or PDA, or handheld computer, or netbook, or laptop) is called application processor.

In an exemplary embodiment, a program executed by the control processing element is stored in one or a plurality of storage devices. Depending on the embodiments, when a program is stored, the program can be in the original form, or in encoded form, or in encrypted form, or in compressed form.

An electronic storage device is any medium that can be used to record information electronically (e.g., volatile DRAM, or non-volatile storage, or solid state drive, or hard disk, or flash memory). In an exemplary embodiment, an electronic storage device can comprise non-volatile random access memory. A non-volatile random access memory retains its information when power is turned off (non-volatile). The memory can be integrated on-chip (e.g., non-volatile SRAMs, or on-chip flash memory) or it can be off-chip (e.g., flash memory, or ferroelectric RAM, or magnetoresistive random-access memory, or phase-change memory, or nano-RAM, or millipede memory, or resistive random-access memory). In an exemplary embodiment, a computing apparatus can store fingerprint templates in a non-volatile storage device.

In an exemplary embodiment of the identity skin (1000), a biometric sensor (1100) is a device that can sense biometric identity of a mobile user (e.g., fingerprint imager, or palm print imager, or finger vein imager). A readout circuit is a device that can configure and/or read output data from a biometric sensor. In further embodiments, an identity skin communicates with a mobile computing apparatus through a connector interface.

Depending on the implementation, the connector interface (1300) that couples a mobile computing apparatus and an identity skin can comprise a serial connector (e.g., USB, or firewire, or I2C, or SPI), or parallel connector, or wireless connector (e.g., near field wireless communication, or bluetooth). An identity skin can communicate with the mobile computing apparatus through the connector interface.

In some exemplary embodiments, the readout circuit (1200) of an identity skin can transmit original sensed, and/or processed, and/or extracted biometric data (e.g., original fingerprint image, or processed fingerprint image, or extracted biometric features), and/or retrieved identity information (e.g., user identity) to a mobile computing apparatus.

In further embodiments, a mobile computing apparatus can configure and/or control an attached identity skin through the connector interface.

In some exemplary embodiments, an identity skin can be a stand-alone apparatus that can be added to a mobile computing apparatus. In alternative exemplary embodiments, an identity skin can be pre-installed on a mobile computing apparatus and/or integrated with a mobile computing apparatus by the mobile computing apparatus vendor.

It is worth to point out that the described embodiments are only for illustration purpose. Equivalent embodiments may be readily apparent to those of ordinary skill in the art. The present invention should not be limited only to the described embodiments herein.

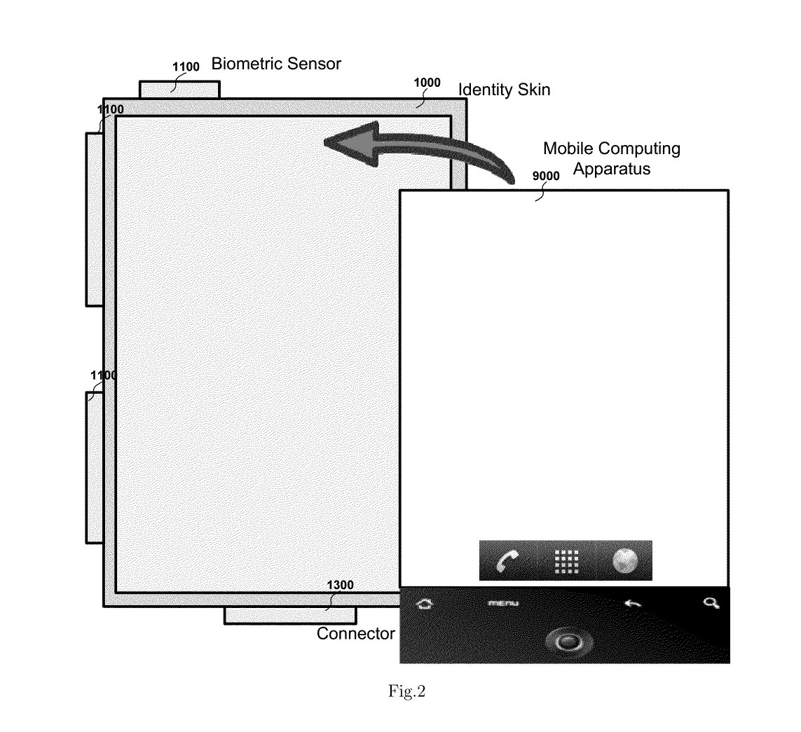

FIG. 2 is a block diagram showing, in one exemplary embodiment of the present invention, an alternative arrangement of identity skin. Depending on the embodiments, biometric sensors (1100) can be situated in different positions of an identity skin.

In one exemplary embodiment, biometric sensors (e.g., fingerprint imager, or palm print imager, or finger vein imager) can be arranged on the side of an identity skin. For instance, in some embodiments, one or multiple fingerprint imagers or finger vein imagers can be put along either side and/or both sides of an identity skin.

In alternative exemplary embodiments, biometric sensors (e.g., fingerprint imager, or palm print imager, or finger vein imager) can be arranged on the top and/or bottom of an identity skin. For instance, in some embodiments, one or multiple fingerprint imagers or finger vein imagers can be put on top side of an identity skin.

In other alternative exemplary embodiments, biometric sensors (e.g., fingerprint imager, or palm print imager, or finger vein imager) can be arranged on the backside of an identity skin. For instance, in some embodiments, one or multiple biometric sensors (e.g., fingerprint imager, or palm print imager, or finger vein imager) can be put on the back of an identity skin.

Depending on the embodiments, biometric sensors (e.g., fingerprint imager, or palm print imager, or finger vein imager) can be put in any side or any multiple sides of an identity skin.

It is worth to point out that the described embodiments are only for illustration purpose. Equivalent embodiments may be readily apparent to those of ordinary skill in the art. The present invention should not be limited only to the described embodiments herein.

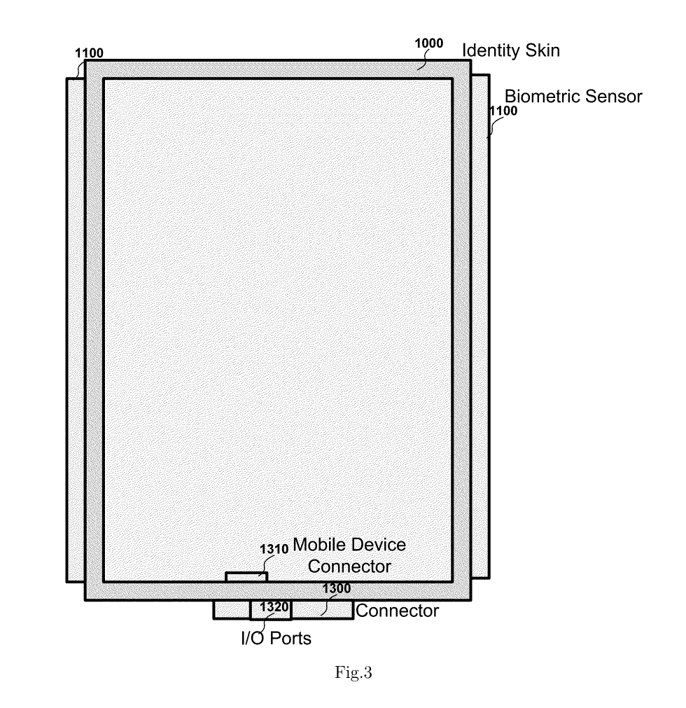

FIG. 3 is a block diagram showing, in one exemplary embodiment of the present invention, the components of an identity skin comprising (1000), one or a plurality of biometric sensors (1100), a readout circuit (1200), and a connector (1300) that comprises a connection port (1310) to a mobile computing apparatus and additional input/output ports (1320).

In some exemplary embodiments, an identity skin can comprise a connector interface that couples a mobile computing apparatus and an identity skin.

In additional embodiments, the connector interface can comprise a mobile computing apparatus connector for transmitting signals between a mobile computing apparatus and an identity skin. Depending on the implementation, the mobile computing apparatus connector of an identity skin can comprise a serial connector (e.g., USB, or firewire, or I2C, or SPI), or a parallel connector, or wireless connector (e.g., near field wireless communication, or bluetooth). An identity skin can communicate with the mobile computing apparatus through the mobile computing apparatus connector interface.

In further embodiments, the connector interface can comprise a communication hub or switch (e.g., USB hub) that expands the number of input/output ports so that one and/or multiple devices can connect to a mobile computing apparatus.

In additional embodiment, the connector interface can comprise one or multiple interface convertors that can convert between communication standards (e.g., USB to I2C, or USB to firewire).

It is worth to point out that the described embodiments are only for illustration purpose. Equivalent embodiments may be readily apparent to those of ordinary skill in the art. The present invention should not be limited only to the described embodiments herein.

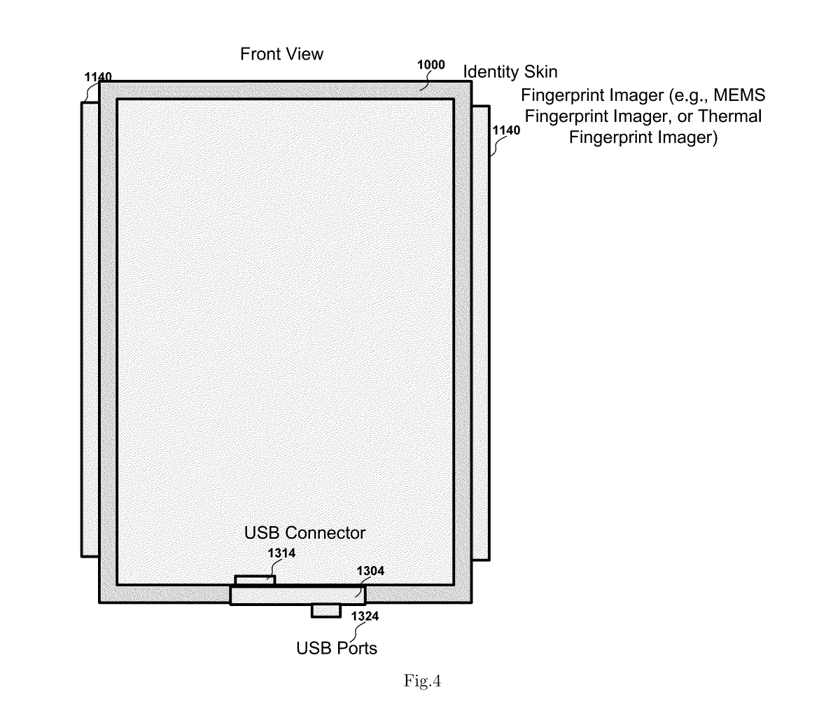

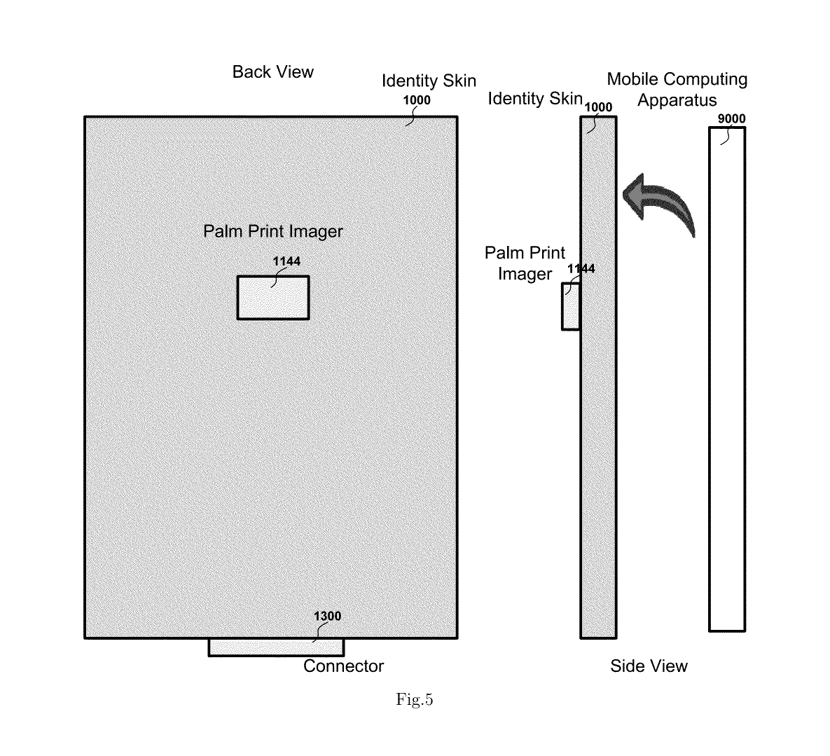

FIG. 4 is a block diagram showing, in one alternative exemplary embodiment of the present invention, the components of an identity skin comprising, one or a plurality of fingerprint imagers (1140), a readout circuit, and a connector that comprises a USB port to a mobile computing apparatus (1314) and additional USB input/output ports (1324).

The number of fingerprint imagers (e.g., optical fingerprint imagers, or ultrasonic fingerprint imagers, or thermal fingerprint imagers, or capacitive fingerprint imagers, or MEMS based fingerprint imagers, or fingerprint imagers built from nano materials such as nao tubes, or nano wires, or nano sheet) depends on the implementation. Different embodiments can choose different number of fingerprint imagers. Placement of the fingerprint imagers (e.g., optical fingerprint imagers, or ultrasonic fingerprint imagers, or thermal fingerprint imagers, or capacitive fingerprint imagers, or MEMS based fingerprint imagers, or fingerprint imagers built from nano materials such as nao tubes, or nano wires, or nano sheet) also depends on the implementation (e.g., on the side, or at the top, or on the back). An embodiment can comprise a plurality of biometric sensors (e.g., fingerprint imager, or palm print imager, or finger vein imager). Furthermore, a biometric sensor can be placed on any side or any multiple sides of an identity skin. The present invention is not limited to any particular number of fingerprint imagers or limited to any specific placement or arrangement of fingerprint imagers. The described embodiments are for the purpose of illustration.

Depending on the embodiments, a fingerprint imager can take any form (e.g., regular shape, or irregular shape, or planar shape, or 3D shape, or form of a sheet). Furthermore, in some exemplary embodiments, a fingerprint imager can be overlayed on top of flexible (e.g., plastic) and/or transparent substrate.

In an exemplary embodiment, fingerprint imagers can use the form of a sheet. A sheet of fingerprint imagers can wrap around the edges of a mobile computing apparatus or identity skin. In furthermore exemplary embodiments, the fingerprint imager sheet may comprise one or multiple holes that expose the connection interfaces of a mobile computing apparatus and/or identity skin. Furthermore, the edges of an identity skin can be covered by one or a plurality of fingerprint imagers.

The fingerprint imagers are controlled by a readout circuit. In exemplary embodiments, a readout circuit can collect fingerprint data from a coupled fingerprint imager. In further embodiments, a readout circuit can process and/or match fingerprint images.

FIG. 4 is a block diagram showing, in one alternative exemplary embodiment of the present invention, the components of an identity skin comprising, a palm print imager (1144), and a connector that couples the identity skin with a mobile computing apparatus (9000).

In an exemplary embodiment, a palm print imager can be placed on the back of an identity skin (e.g., the side facing a human hand when a mobile computing apparatus is held by a person).

Depending on the embodiments, an identity skin can comprise a readout circuit that can collect palm print image from a coupled palm print imager. In further embodiments, a readout circuit can process and/or match palm print images.

In an exemplary embodiment, a mobile computing apparatus and/or an identity skin can start the process of collecting palm print when the mobile computing apparatus and/or the identity skin detects that the mobile computing apparatus is held by human hand.

In further exemplary embodiments, a mobile computing apparatus and/or an identity skin can comprise one or a plurality of sensors (e.g., motion detector, or thermal sensor, or temperature sensor, or light sensor, or optical sensor, or image sensor, or microphone, or location sensor, or accelerometer, or tilt sensor, or gyroscope sensor) that can be used to detect when and/or whether the mobile computing apparatus is held by human hand. For example, in one exemplary embodiment, from the pattern of accelerometer data, a mobile computing apparatus can decide if it is held by human hand or not.

In alternative exemplary embodiments, a mobile computing apparatus and/or an identity skin can start the process of collecting data from a palm print imager when the mobile computing apparatus detects interaction between a user and the mobile computing apparatus. In further exemplary embodiments, a mobile computing apparatus and/or an identity skin can comprise a touch panel (e.g., out-cell touch panel, or in-cell touch, or on-cell touch). According to touch sensing, a mobile computing apparatus can decide if it is held by human hand or not.

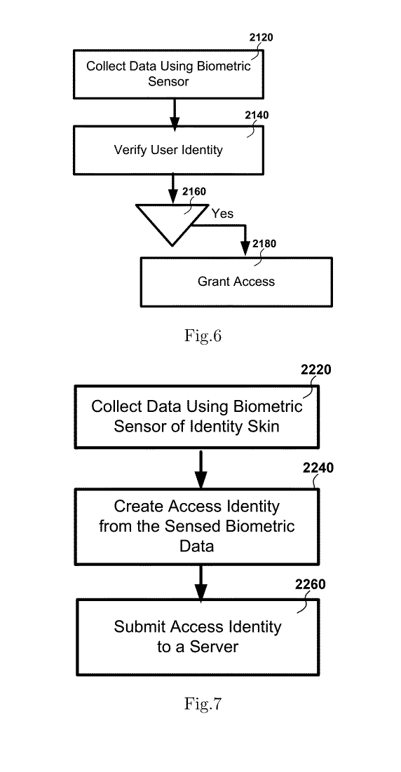

FIG. 6 is a flow chart showing, in one exemplary embodiment of the present invention, the method of using identity skin for enforcing access control.

In an exemplary embodiment, a mobile computing apparatus can use an identity skin for access management (e.g., access to a mobile computing apparatus, access to a mobile computing apparatus service, or access to a mobile computing apparatus function). For instance, for verifying if a user is allowed to unlock a mobile computing apparatus, or access a service or function provided by a mobile computing apparatus, or access a document stored in a mobile computing apparatus, the mobile computing apparatus can, collect biometric data using a biometric sensor of the identity skin (2120). The mobile computing apparatus or readout circuit can verify user identity using the collected biometric data (2140). When the user's identity can be verified (2160) such that the user has the required access privilege, the mobile computing apparatus will grant access to the user (2180).

In one exemplary embodiment, a mobile computing apparatus can use an identity skin to determine if a mobile user has the privilege to unlock a mobile computing apparatus. For instance, when a user's identity can be verified using biometric data collected from an identity skin and the user has the privilege to unlock the mobile computing apparatus, the mobile computing apparatus will unlock.

In an exemplary embodiment, a mobile computing apparatus can use an identity skin to determine if a mobile user has the privilege to launch a mobile application (e.g., a mobile app). For instance, when a user's identity can be verified using biometric data collected from an identity skin and the user has the privilege to launch the mobile application, the mobile computing apparatus will launch the mobile application.

In an exemplary embodiment, a mobile computing apparatus can use an identity skin to determine if a mobile user has the privilege to open an electronic document file (e.g., pdf file, or word file, or xml file, or excel file, or audio file, or movie file, or text file, or video file, or image file, or database file, or electronic form, or electronic mail, or electronic message, or archive file). For instance, when a user's identity can be verified using biometric data collected from an identity skin and the user has the privilege to open the document file, the mobile computing apparatus will open the document.

In an exemplary embodiment, a mobile computing apparatus can use an identity skin to determine if a mobile user has the privilege to access a peripheral device (e.g., camera, or microphone, or SIM card, or any device attached to a mobile computing apparatus through input/output port). For instance, when a user's identity can be verified using biometric data collected from an identity skin and the user has the privilege to use a camera, the mobile computing apparatus will allow the user to use the camera.

In further exemplary embodiments, a mobile computing apparatus can use an identity skin to determine if a mobile user has the privilege to access and/or control a device (e.g., physical entrance, or car control, or printer, or digital control panel of a physical facility, or an electronic appliance) that directly or indirectly connects with the mobile computing apparatus over a transceiver (e.g., wired transceiver, or wireless transceiver, or bluetooth transceiver, or near field communication transceiver). For instance, when a user's identity can be verified using biometric data collected from an identity skin and the user has the privilege to use a printer, permission will be granted to the user to use the printer.

In additional exemplary embodiments, for a captured fingerprint, before it is admitted, its quality can be evaluated. Low quality fingerprint data can be discarded. The admitted fingerprint will be used for identity verification by matching it with one or a plurality of fingerprint templates.

In one exemplary embodiment, a mobile computing apparatus or identity skin can verify the identity of a user based on the fingerprint data captured by the fingerprint imager(s). A user's identity is established when the fingerprint sample(s) is used to identify a user. A fingerprint is formed from the skin uneven surface of ridges and valleys.

Depending on the embodiments, fingerprint templates can be stored in an identity skin, or stored in a mobile computing apparatus, or stored in servers that provide centralized identity service.

In accordance with the present invention, there can be a user identity repository. The repository can store the biometric identity data for one or a plurality of users (e.g., owner or primary user of a mobile computing apparatus, and/or children of the primary user of a mobile computing apparatus, and/or spouse of the primary user of a mobile computing apparatus, and/or colleagues of the primary user of a mobile computing apparatus, and/or friends of the primary user of a mobile computing apparatus, and/or administrator of a mobile computing apparatus). Depending on the embodiments, a biometric identity comprises an image, or other captured sample, in its original, or processed (e.g., features or fingerprint template), or enhanced, or compressed form.

Depending on the embodiments, the user identity repository can be stored in an identity skin, or stored in a mobile computing apparatus, or stored in servers that provide centralized identity service.

In further exemplary embodiment, a user identity repository can be stored in one or a plurality of storage devices (e.g., non-volatile memory, or DRAM, or flash, or solid state storage device).

In some exemplary embodiments, biometric data processing and/or identity verification can be implemented as one or multiple mobile applications (e.g., apps).

In an exemplary embodiment, a mobile computing apparatus can prompt a mobile user to input biometric data (e.g., rub or touch a fingerprint sensor, or take a palm print image, or take finger vein image). For instance, depending on the implementations, a mobile computing apparatus can show one or a plurality of user interface artifacts (e.g., dialog window, or icon, or widget, or menu, or popup window) to prompt a mobile user.

In an exemplary embodiment, a mobile computing apparatus and/or an identity skin can start the process of collecting data from a biometric sensor (e.g., fingerprint imager, or palm print imager, or finger vein imager) when the mobile computing apparatus and/or the identity skin detects that the mobile computing apparatus is held by human hand.

In further exemplary embodiments, a mobile computing apparatus and/or an identity skin can comprise one or a plurality of sensors (e.g., motion detector, or thermal sensor, or temperature sensor, or light sensor, or optical sensor, or image sensor, or microphone, or location sensor, or accelerometer, or tilt sensor, or gyro) that can be used to detect when and/or whether the mobile computing apparatus is held by human hand. For example, in one exemplary embodiment, from the pattern of accelerometer data, a mobile computing apparatus can decide if it is held by human hand or not.

In alternative exemplary embodiments, a mobile computing apparatus and/or an identity skin can start the process of collecting data from a biometric sensor (e.g., fingerprint imager, or palm print imager, or finger vein imager) when the mobile computing apparatus detects interaction between a user and the mobile computing apparatus. In further exemplary embodiments, a mobile computing apparatus and/or an identity skin can comprise a touch panel (e.g., out-cell touch panel, or in-cell touch, or on-cell touch). According to touch sensing, a mobile computing apparatus can decide if it is held by human hand or not.

In alternative exemplary embodiments, a mobile computing apparatus and/or an identity skin can comprise one or a plurality of keypads. By sensing the keypad status, a mobile computing apparatus can decide if it is held by human hand or not.

In some exemplary embodiments, any of the processing steps described as specification of FIG. 6 can be implemented as a software program. In an exemplary embodiment, the software program can be stored in an electronic storage device (e.g., flash memory, or solid state drive, or volatile memory, or PCM non-volatile memory, or hard drive). Depending on the embodiments, the electronic storage device can be part of a mobile computing apparatus, or part of an identity skin, or attached to a mobile computing apparatus or identity skin over wired or wireless connection.

In additional exemplary embodiments, the software program can program a control processing element of a mobile computing apparatus to perform any of the processing steps described as specification of FIG. 6. For example, depending on the embodiments, a control processing element or an identity skin can be programmed to, collect data using a biometric sensor of an identity skin; verify user identity using the collected biometric data; and grant access (e.g., access to the mobile computing apparatus, or access to a service offered by the mobile computing apparatus, or a function offered by the mobile computing apparatus) according to the user identity.

In some exemplary embodiments, a mobile computing apparatus can download the software program that can perform any of the processing steps described as specification of FIG. 6 over networks using its transceiver. Depending on the implementation, a mobile computing apparatus can send a download request to a server. The server can provide a download service to mobile computing apparatuses (e.g., app store, or HTTP server, or FTP server, or HTTPS server).

It is worth to point out that the described embodiments are only for illustration purpose. Equivalent embodiments may be readily apparent to those of ordinary skill in the art. The present invention should not be limited only to the described embodiments herein.

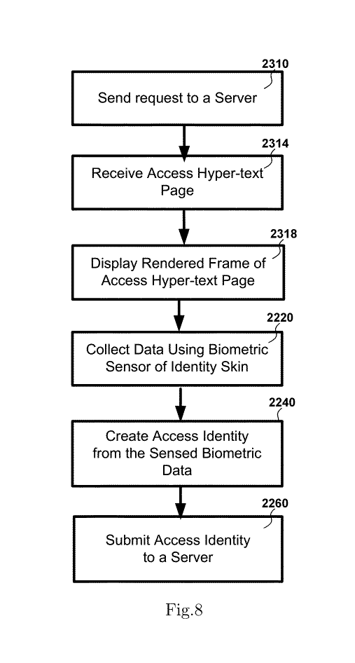

FIG. 7 is a flow chart showing, in one exemplary embodiment of the present invention, the method of using identity skin for access control over networks;

In an exemplary embodiment, a mobile computing apparatus can use an identity skin for access management (e.g., access to a server, or access to services provided by servers, or access to resources over networks). For instance, collect biometric data using a biometric sensor of the identity skin (2220), create an access identity from the collected biometric data (2240), and submit the access identity by the mobile computing apparatus to a server over networks (2260). The mobile computing apparatus or readout circuit can verify user identity using the collected biometric data. When the user's identity can be verified such that the user has the required access privilege, the mobile computing apparatus will grant access to the user.

In some exemplary embodiments, a mobile computing apparatus or identity skin can support a service access credential repository. The service access credential repository can be used to support access to services (e.g., access to remote servers, or services provided by networked servers, or resources), and/or support identity management. A server can enforce access control to the services that it hosts. For example, it allows an authorized user with certain access credential to access the service. An access credential is used to control access to service and/or other resources in information system. The combination of a user account number or name and a secret password is an example of credentials. There are other forms of documentation of credentials, such as biometrics: fingerprints, voice recognition, retinal scans, facial recognition systems, or X.509, public key certificate, and etc.

In an exemplary embodiment, the service credential repository comprises a collection of service credential records. A service biometric credential record associates a service reference (e.g., URL, or universal global id, or name, or domain, or identifier, or string, or ip address, or network address, or service access point, or a service call interface) with a user's biometric identity, and/or access credential to the service. A service is usually offered by one or a plurality of servers. The service credential repository can be stored in an electronic storage device (e.g., volatile or non-volatile, or on-chip or off-chip).

In an exemplary embodiment, a service credential record can comprise, a service reference, an access credential, and a biometric identity. A biometric identity comprises an image, or other captured biometric sample, in its original, enhanced or compressed form or a biometric template (original, or enhanced, or compressed, or protected, or encrypted form). Furthermore, a biometric identity can comprise a reference to an image, or reference to other captured biometric sample, in its original, enhanced or compressed form or reference to a biometric template (original, or enhanced, or compressed, or protected, or encrypted form).

In an exemplary embodiment, an access credential can comprise a public private key pair. A public-private key pair is a cryptographic approach which involves the use of asymmetric key algorithms instead of or in addition to symmetric key algorithms.

In one exemplary embodiment, an access credential can comprise a biometric template or reference to a biometric template. A biometric template is a digital reference of distinct characteristics that have been extracted from a biometric sample. Templates are used during the biometric authentication process.

In one exemplary embodiment, an access credential can comprise an electronic access token. An electronic access token is a token that contains the security information for a login session and identifies the user, the user's groups, or the user's privileges.

In additional exemplary embodiments, an access token can comprise a biometric token. A biometric token is a digital security token created from biometric data (e.g., one or multiple original fingerprint images, or features extracted from one or multiple fingerprint images, or one or multiple processed fingerprint images, or one or multiple original palm print images, or features extracted from one or multiple palm print images, or one or multiple processed palm print images, or one or multiple original finger vein images, or features extracted from one or multiple finger vein images, or one or multiple processed finger vein images). A biometric token can be used to control access to a local or a networked resource, or authenticate a user, or prove one's identity electronically (e.g., a user trying to access a networked resource). In additional exemplary embodiments, a biometric token can be used in addition to or in place of a password to prove that the user is who they claim to be. A biometric token can act like an electronic key to access something (e.g., a networked resource, or a local resource).

In some exemplary embodiments, a biometric token can be created from the original or processed biometric data (e.g., fingerprint image, or finger vein image, or palm print image), or created from one or a plurality of features extracted from the original or processed biometric image. In addition, biometric token can be created by applying one or multiple steps of cryptographic operations to the biometric data.

In some exemplary embodiments, a mobile computing apparatus and/or an identity skin can comprise a crypto processor that can create a biometric token from biometric data. Depending on the embodiments, a crypto processor is a component for carrying out cryptographic and/or security operations. Depending on the implementation, a crypto processor can provide support for creating public-private key pair (e.g., DiffieHellman key exchange protocol, or DSS, or ElGamal, or various elliptic curve techniques, or Paillier crypto schemes, or RSA encryption approaches, or CramerShoup crypto schemes), or verifying electronic certificates, or signing digital signatures (e.g., RSA based signature, or DSA based signature, or elliptic curve based DSA, or ElGamal signature, or Rabin signature approach, or Pairing based signature scheme, or undeniable signature, or aggregate signature), or computing message authentication codes for digital data, or performing mutual authentications, or carrying out symmetric key encryption (e.g., Twofish, or Serpent, or AES, or Blowfish, or CAST5, or RC4, or 3DES, or IDEA), or performing digital hash functions (e.g., Gost, or Haval, or MD5, or Panama, or Ripemd, or SHA-1, or SHA-256, or SHA-512, or SHA-3, or Whirlpool). A computing apparatus can create a biometric token by applying one or multiple cryptographic operations on fingerprint data (e.g., in original form, or in processed form, or features extracted from fingerprint images). Depending on the embodiments, as one step of biometric token creation, a computing apparatus can apply a one-way hash operation to fingerprint data (e.g., in original form, or in processed form, or features extracted from fingerprint images).

In one exemplary embodiment, the service credential repository stores a collection of service credential records in a persistent electronic storage.

In one exemplary embodiment, a credential processor is a processing component used to provide access credential to a server. It retrieves an access credential from a service biometric credential record that matches with the captured biometric data of a user.

In some exemplary embodiments, any of the processing steps described as specification of FIG. 7 can be implemented as a software program. In some exemplary embodiments, the software program can be stored in an electronic storage device (e.g., flash memory, or solid state drive, or volatile memory, or PCM non-volatile memory, or hard drive). Depending on the embodiments, the electronic storage device can be part of a mobile computing apparatus, or part of an identity skin, or attached to a mobile computing apparatus or identity skin over wired or wireless connection.

In additional exemplary embodiments, the software program can program a control processing element of a mobile computing apparatus to perform any of the processing steps described as specification of FIG. 7. For example, depending on the embodiments, a control processing element or an identity skin can be programmed to, collect data using a biometric sensor of the identity skin; create an access identity and/or biometric token from the collected biometric data; and submit the access identity and/or biometric token to a server over network.

In some exemplary embodiments, a mobile computing apparatus can download the software program that can perform any of the processing steps described as specification of FIG. 7 over networks using its transceiver. Depending on the implementation, a mobile computing apparatus can send a download request to a server. The server can provide a download service to mobile computing apparatuses (e.g., app store, or HTTP server, or FTP server, or HTTPS server).

FIG. 8 is a flow chart showing, in one alternative exemplary embodiment of the present invention, the method of using identity skin for accessing service over network.

In an exemplary embodiment, when a user wants to access a service using a mobile computing apparatus, the mobile computing apparatus can send a request to the server over networks (2310). In response to the request, the server sends a hyper-text page to the mobile computing apparatus (e.g., a login page, or a page for establishing a login session, or a page for creating a connection) (2314).

A server is a computer system used to run one or more services as a host to serve the needs of clients on the networks. A client is a computing system that can connect to a server over networks. Depending on the computing service, it could be a database server, or a file server, or a mail server, or a print server, or a web server, or a gaming server, or a server that allows a user to control and/or operate a machine (e.g., vehicle, or weapon system, or mechanical system, or robot, or physical entrance). Depending on the implementations, a server can be a real computer or a virtual server. A server can provide access to a resource (e.g., physical resource, or virtual resource, or logical resource, or digital resource) as a service.

In additional embodiments, the server can enforce access control to the services that it hosts. For example, it allows authorized user to access the service. The identity skin and/or mobile computing apparatus can verify user identity and demonstrate to the server that a service is accessed by an authorized user.

In one exemplary embodiment, the request can be sent from a browser executed by the mobile computing apparatus.

In another exemplary embodiment, the request can be sent from an application executed by the mobile computing apparatus.

The hyper-text page returned from the server is rendered by the mobile computing apparatus (2318). Apart from text, hyper-text may contain widget, or menus, or buttons, or tables, or images, or video clips.

In an exemplary embodiment, when and/or after a hyper-text page is displayed by a mobile computing apparatus, a user can interact with the biometric sensor of an identity skin. The identity skin can collect biometric data from the user.

In exemplary embodiments where the biometric sensor is a fingerprint imager, for a captured fingerprint, before it is admitted for fingerprint recognition, its quality can be evaluated. Low quality finger-print data can be discarded. Fingerprint recognition will be applied to the admitted fingerprint by the mobile computing apparatus or the identity skin. An access identity will be created.

An access identity can comprise a collection of attributes. In one embodiment, an access identity can comprise access credential associated with a user and a service. Access credential is used for controlling accesses to service and/or resources. Access credential includes but not limited to, password, or biometric identity (e.g., fingerprint template or reference to fingerprint template), or public private key pair, or secret key, or data encrypted using a private key, or data encrypted using a secret key shared between a server and a mobile computing apparatus or an identity skin.

In some exemplary embodiments, an access identity can comprise a biometric token.

In an embodiment, the access credential associated with a service and a user is stored in a service biometric credential repository. When an access identity is created, the relevant credential information (e.g., password, or biometric identity, or private key, or secret key) is retrieved from the service biometric credential repository based on the captured biometric data (e.g., fingerprint data, or palm print data, or finger vein data).

In an embodiment, the computing system can submit the access identity to the server. The access identity can be sent by the mobile computing apparatus to the sever using its transceiver. Depending on the embodiments, the access identity can be submitted using hap, or TCP/IP, or any network protocol, or any remote procedure call interface.

In additional exemplary embodiments, the submitted access identity can comprise a nonce encrypted by the identity skin or the mobile computing apparatus. Depending on the implementations, the nonce can be sent from the server. Furthermore, in an embodiment, the nonce can be encrypted by the private key embedded in an identity skin or a mobile computing apparatus. Or in an alternative embodiment, the nonce can be encrypted by a key taken from the access credential. For example, if the access credential comprises a public private key pair, the nonce can be encrypted using the private key. Alternatively, if the access credential comprises a secret key, the nonce can be encrypted using the secret key.

In additional embodiments, the submitted access identity can comprise a session key (e.g., secret key shared between the server and the identity skin or the mobile computing apparatus). The session key can be encrypted.

In further embodiments, the submitted access identity can be signed with digital signature or message authentication code by the identity skin or the mobile computing apparatus.

In some exemplary embodiments, any of the processing steps described as specification of FIG. 8 can be implemented as a software program. In some exemplary embodiments, the software program can be stored in an electronic storage device (e.g., flash memory, or solid state drive, or volatile memory, or PCM non-volatile memory, or hard drive). Depending on the embodiments, the electronic storage device can be part of a mobile computing apparatus, or part of an identity skin, or attached to a mobile computing apparatus or identity skin over wired or wireless connection.

In additional exemplary embodiments, the software program can program a control processing element of a mobile computing apparatus to perform any of the processing steps described as specification of FIG. 8. For example, in some embodiments, a control processing element can be programmed to, send a request to the server using one or a plurality of its transceivers; receive a hyper-text page from the server; and display rendered image frame of the hyper-text page by the mobile computing apparatus. Depending on the implementations, either before, or during, or after a hyper-text page is received and/or rendered, a control processing element or identity skin can be programmed to collect data using a biometric sensor of the identity skin, and create an access identity and/or biometric token from the collected biometric data. In further exemplary embodiments, a control processing element can be programmed to submit the access identity and/or biometric token to a server using one or a plurality of its transceivers.

In some exemplary embodiments, a mobile computing apparatus can download the software program that can perform any of the processing steps described as specification of FIG. 8 over networks using its transceiver. Depending on the implementation, a mobile computing apparatus can send a download request to a server. The server can provide a download service to mobile computing apparatuses (e.g., app store, or HTTP server, or FTP server, or HTTPS server).

In some embodiments, a mobile computing apparatus can download software applications (e.g., apps) over networks from one or a plurality of servers where the downloaded applications can program the mobile computing apparatus to use an identity skin for access control. Depending on the embodiments, the application can be compressed, and/or encoded, and/or encrypted. The application can be in the form of native binary (e.g., a program that can be executed by a processing element of a mobile computing apparatus), or in the form of script program (e.g., python, or ruby, or javascript, or lua, or other similar script language), or in the form of a program using a virtual machine language (e.g., Java).

In an exemplary embodiment, a mobile computing apparatus can download the mobile application over networks using its transceiver. Depending on the implementation, a mobile computing apparatus can send a download request to a server. The server can provide a mobile application download service to mobile computing apparatuses (e.g., app store, or HTTP server, or FTP server, or HTTPS server).

In an exemplary embodiment, a mobile application can program a mobile computing apparatus to use an identity skin for access management (e.g., access to a mobile computing apparatus, or access to a mobile computing apparatus service, or access to a mobile computing apparatus function). A mobile computing apparatus can be programmed by a mobile application to, collect biometric data using a biometric sensor of the identity skin. In further exemplary embodiment, a mobile application can program a mobile computing apparatus to verify user identity using the collected biometric data. When the user's identity can be verified such that the user has the required access privilege, the mobile computing apparatus can be programmed by the mobile application to grant access to the user.

In an exemplary embodiment, a mobile application can program a mobile computing apparatus to use an identity skin for access management (e.g., access to a server, or access to services provided by servers, or access to resources over networks). A mobile computing apparatus can be programmed by a mobile application to, collect biometric data using a biometric sensor of the identity skin, create an access identity from the collected biometric data, and submit the access identity by the mobile computing apparatus to a server over networks.

It should be understood that there exists implementations of other variations and modifications of the invention and its various aspects, as may be readily apparent to those of ordinary skill in the art, and that the invention is not limited by the specific embodiments described herein.

What is claimed is:

1. An identity skin apparatus comprising,
at least one biometric sensor;
a readout circuit coupling with the biometric sensor; and
a connector wherein said connector coupling the identity skin with a mobile computing apparatus wherein said mobile computing apparatus further comprising at least one transceiver, at least one control processing element, and said connector comprising at least one input and/or output port.

2. The apparatus in claim 1 wherein the biometric sensor is a fingerprint imager.

3. The fingerprint imager in claim 2 is a capacitive fingerprint imager.

4. The fingerprint imager in claim 2 is an optical fingerprint imager.

5. The fingerprint imager in claim 2 is a MEMS fingerprint imager.

6. The apparatus in claim 1 wherein the biometric sensor is a palm print imager.

7. The apparatus in claim 1 wherein the biometric sensor is a finger vein imager.

8. The apparatus in claim 1 wherein the connector further comprising a serial communication interface wherein said serial communication interface coupling the identity skin with the mobile computing apparatus.

9. The apparatus in claim 1 wherein the connector further comprising a parallel communication interface wherein said parallel communication interface coupling the identity skin with the mobile computing apparatus.

10. The apparatus in claim 1 wherein the connector further comprising an input/output hub wherein said input/output hub comprising a plurality of input and/or output ports.

11. A method of using identity skin to control access to a mobile computing apparatus, or access to a service offered by a mobile computing apparatus, or access to a function offered by a mobile computing apparatus wherein said identity skin coupling with the mobile computing apparatus wherein said mobile computing apparatus comprising at least one transceiver and at least one control processing element, said method comprising,
collecting data using a biometric sensor of the identity skin wherein said identity skin comprising, at least one biometric sensor; a readout circuit coupling with the biometric sensor; and a connector wherein said connector coupling the identity skin with the mobile computing apparatus;
verifying user identity using the collected biometric data; and
granting access by the mobile computing apparatus according to the user identity.

12. The method of granting access in claim 11 further comprising unlocking the mobile computing apparatus.

13. The method of granting access in claim 11 further comprising launching a mobile application wherein only a user with certain identity having permission to start said mobile application.

14. The method of granting access in claim 11 further comprising opening a document file wherein only a user with certain identity having permission to open said document file.

15. The method of granting access in claim 11 further comprising initiating the process of collecting biometric data from a biometric sensor when the mobile computing apparatus detects that the device is held by human hand.

16. The method of granting access in claim 11 further comprising initiating the process of collecting biometric data from a biometric sensor when the mobile computing apparatus detects interaction between a user and the mobile computing apparatus.

17. A method of using identity skin to control access to services or resources over network via a mobile computing apparatus wherein said identity skin coupling with the mobile computing apparatus wherein said mobile computing apparatus comprising at least a transceiver and at least one control processing element, said method comprising,
collecting data using a biometric sensor of the identity skin wherein said identity skin comprising, at least one biometric sensor; a readout circuit coupling with the biometric sensor; and a connector wherein said connector coupling the identity skin with the mobile computing apparatus;
creating an access identity and/or biometric token from the collected biometric data; and
submitting the access identity and/or biometric token by the mobile computing apparatus to a server over network.

18. The method in claim 17 further comprising,
sending a request to a server over network;
receiving a hyper-text page from the server; and
displaying rendered image frame of the hyper-text page by the mobile computing apparatus.

19. The method in claim 17 further comprising, computing a biometric token from the collected biometric data.

20. The method in claim 17 further comprising,
verifying user identity from the collected biometric data; and
retrieving an access identity wherein said retrieved access identity is associated with the biometric data and/or verified user identity.
